(19) United States
(12) Patent Application Publication
(10) Pub. No.: US 2012/0281422 A1
(43) Pub. Date: Nov. 8, 2012

(54) BICYCLE ILLUMINATOR FOR BRIGHTENING TRAFFIC

(76) Inventor: Wen-Sung LEE, Taichung City (TW)

(21) Appl. No.: 13/102,066

(22) Filed: May 6, 2011

(51) Int. Cl. B62J 6/02

(52) U.S. Cl. 362/475

(57) ABSTRACT

A bicycle illuminator for brightening traffic includes a container, a reflecting shell and a transparent cover. Most of light from a light source are reflected by the reflecting shell to pass through the transparent cover ahead. Therefore, a rider has a clear view about the far-ahead traffic at night. The other light is passing through an arc hole, an arc opening and a bottom of the transparent cover directly to provide the rider for a clear view of the front road at night.

### BACKGROUND OF THE INVENTION

1. Field of the Invention

The present invention relates to a bicycle illuminator, more particularly to a bicycle illuminator for brightening traffic which makes a rider identify traffic clearly and prevents the rider from traffic accidents.

2. Description of Related Art

Bicycle activity is more and more popular in the 21st century because bicycle activity is eco-friendly, convenient and entertaining. Many enterprises encourage their employees to go to work by bicycles instead of driving vehicles today. Many people also go shopping or go traveling by bicycles during their leisure time. Therefore, bicycle safety becomes an important topic when bicycle manufacturers design and produce bicycles. The use of lights for night riding is generally recommended or required by bicycle manufacturers as a basic safety precaution. Riders' visibilities are worse at night than in daytime. In order to provide enough illumination for riders to understand the traffic ahead and for drivers to be aware of riders at night, a bicycle illuminator is necessary.

A conventional bicycle illuminator in accordance with the prior art is designed to increase brightness and luminous efficacy. Furthermore, a bicycle illuminator is adapted to provide light within a certain angle. For example, most bicycle headlights are designed with a constant focal length so that the light from the light source is reflected by a reflecting shell. After a reflection at the reflecting shell, the light can move forward to brighten ahead. Although the bicycle headlight can brighten the traffic far ahead, it cannot provide enough light on the front road at the same time. When riders want to understand what happened on the front road, the riders need to turn down the headlight. It is not only inconvenient but dangerous for riders.

The present invention has arisen to mitigate and/or obviate the disadvantages of the conventional.

### SUMMARY OF THE INVENTION

The main objective of the present invention is to provide an improved bicycle illuminator to brighten the far-ahead traffic and the front road at the same time.

To achieve the objective, a bicycle illuminator for brightening traffic comprises a container, a reflecting shell and a transparent cover, the container having a receiving space defined in one end thereof, the reflecting shell and the transparent cover assembled at an entrance of the receiving space, an arc opening defined in the container and located under the entrance of the receiving space, the reflecting shell having a top surface and a reflective mirror connecting with the top surface, the reflective mirror curved inward toward a bottom of the receiving space, a light source set up at the top surface, an arc hole opened along a bottom of the reflective minor wherein the arc hole is corresponding to the arc opening, the transparent cover set at another end of the container and in front of the reflecting shell, most of light from the light source reflected by the reflecting shell to pass through the transparent cover to brighten the far-ahead traffic, the other light from the light source passing through the arc hole of the reflecting shell, the arc opening of the container and a bottom of the transparent cover directly to brighten the front road, the reflective mirror having an upward-reflective area and a downward-reflective area, a curvature of the upward-reflective area different from a curvature of the downward-reflective area, the light source arranged above the arc hole thereby most of light are reflected in the reflecting shell rather than passing through the arc hole directly, the arc hole corresponding to the arc opening, the transparent cover having an arc slot defined therein and corresponding to the arc hole and the arc opening thereby the diffractions at the transparent cover are reduced and the light from arc hole is brightening the front road immediately.

Further benefits and advantages of the present invention will become apparent after a careful reading of the detailed description with appropriate reference to the accompanying drawings.

### BRIEF DESCRIPTION OF THE DRAWINGS

FIG. 1 is an assembled view of a bicycle illuminator for brightening traffic in accordance with the present invention;

FIG. 2 is a cross-sectional view of the bicycle illuminator for brightening traffic in accordance with the present invention;

FIG. 3 is an assembled view of the second embodiment of the bicycle illuminator for brightening traffic in accordance with the present invention;

FIG. 4 is a cross-sectional view of the second embodiment of the bicycle illuminator for brightening traffic in accordance with the present invention.

### DETAILED DESCRIPTION OF THE INVENTION

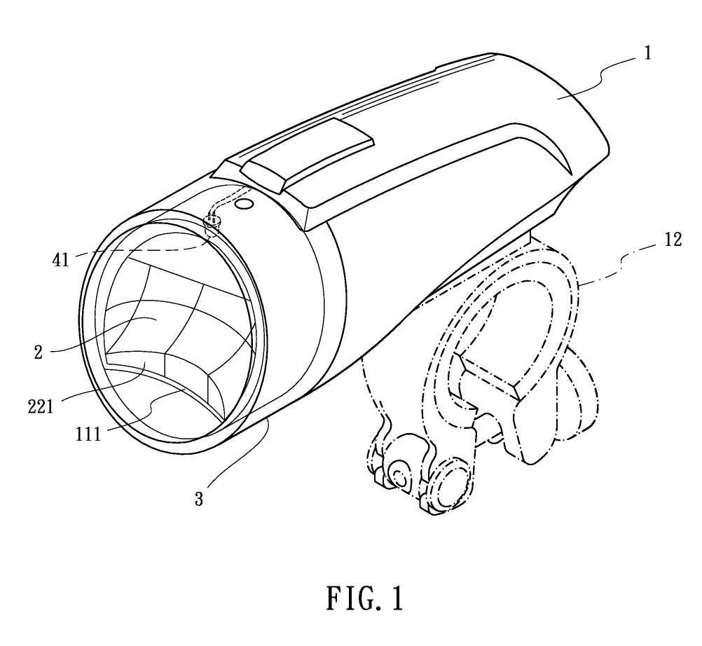

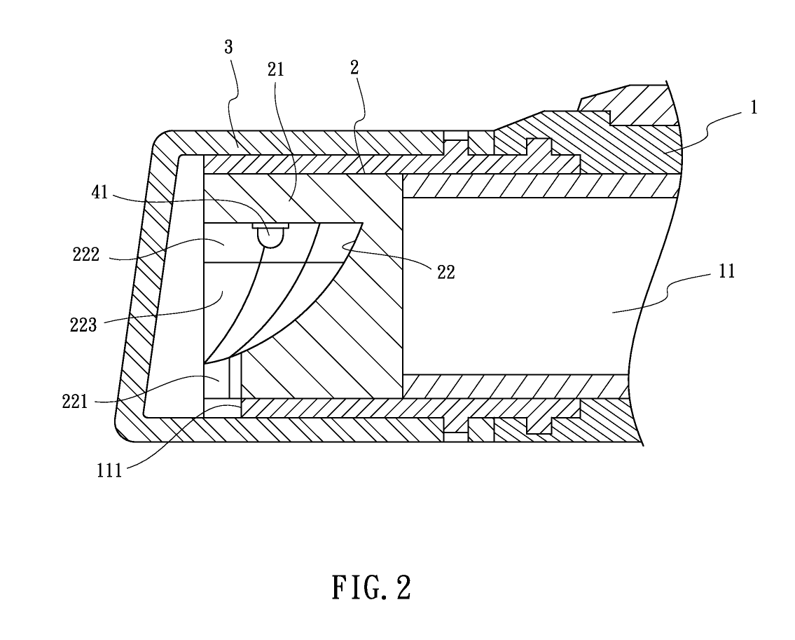

Referring to the drawings to FIGS. 1-2, a bicycle illuminator for brightening traffic in accordance with the present invention comprises a container 1, a reflecting shell 2 and a transparent cover 3.

The container 1 has a receiving space 11 defined in one end thereof. The reflecting shell 2 and the transparent cover 3 are assembled at an entrance of the receiving space 11. An arc opening 111 is defined in the container 1 and is located under the entrance of the receiving space 11. A control circuit and a power supply are assembled in the receiving space 11 (not shown). The control circuit is electrically conducting with the power supply so that a light source 41 is illuminated with electricity. A clamping device 12 is set up at a bottom of the container 1 for clamping a bicycle handlebar.

The reflecting shell 2 has a top surface 21 and a reflective mirror 22 connecting with the top surface 21. The reflective mirror 22 is curved inward toward a bottom of the receiving space 11. The light source 41 (The light source 41 is a light emitting diode or a traditional bulb) is set up at the top surface 21. The light source 41 is electrically conducting with the control circuit. An arc hole 221 is opened along a bottom of the reflective mirror 22, wherein the arc hole 221 is corresponding to the arc opening 111. The reflective mirror 22 has an upward-reflective area 222 and a downward-reflective area 223. A curvature of the upward-reflective area 222 is different from a curvature of the downward-reflective area 223. Therefore, the light from the light source 41 is reflected by the upward-reflective area 222 and the downward-reflective area 223 to brighten the front traffic and the front road simultaneously. The light source 41 is arranged above the arc hole 221, thereby most of light are reflected in the reflecting shell 2 rather than passing through the arc hole 221 directly.

The transparent cover 3 is made of the transparent materials and is formed as a cover. The transparent cover 3 is set at another end of the container 1 and in front of the reflecting shell 2.

Referring to the drawings to FIGS. 1-2, when a rider turns on the bicycle illuminator for brightening traffic, most of light from the light source 41 are reflected by the reflecting shell 2 to pass through the transparent cover 3 in front of the reflecting shell 2. Consequently, the rider has a clear view about the far-ahead traffic at night. The other light from the light source 41 is passing through the arc hole 221 of the reflecting shell 2, the arc opening 111 of the container 1 and a bottom of the transparent cover 3 directly. Consequently, the light from the arc hole 221 is brightening the front road at night.

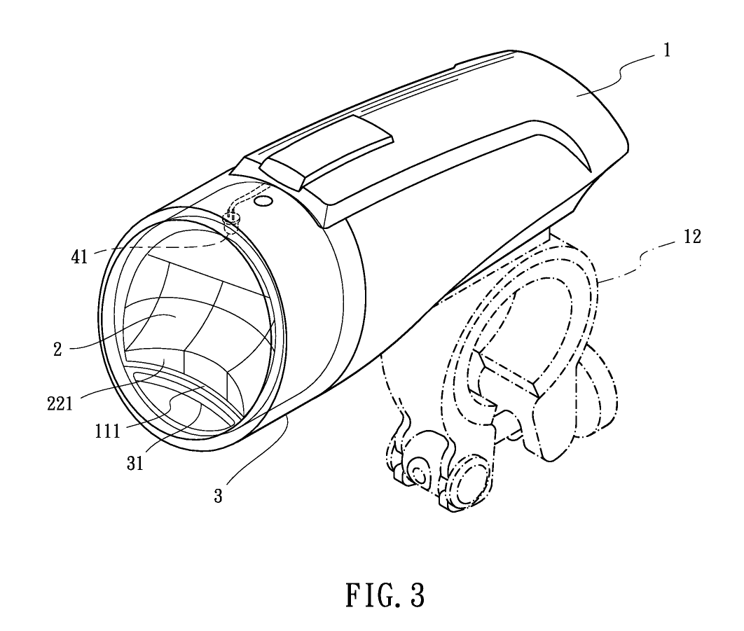

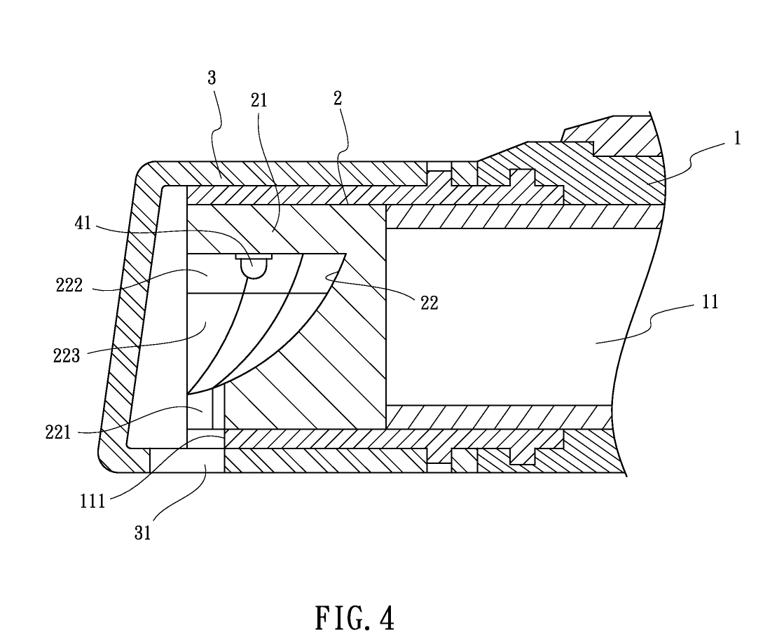

Referring to FIGS. 3-4, a second embodiment of a bicycle illuminator for brightening traffic in accordance with the present invention is illustrated. The transparent cover 3 has an arc slot 31 defined therein and corresponding to the arc hole 221 and the arc opening 111 Therefore, the diffractions at the transparent cover 3 are reduced and the light from the arc hole 221 is brightening the front road immediately.

Although the invention has been explained in relation to its preferred embodiment, it is to be understood that many other possible modifications and variations can be made without departing from the spirit and scope of the invention as hereinafter claimed.

What is claimed is:

1. A bicycle illuminator for brightening traffic comprising:
a container, a reflecting shell and a transparent cover, the container having a receiving space defined in one end thereof, the reflecting shell and the transparent cover assembled at an entrance of the receiving space, an arc opening defined in the container and located under the entrance of the receiving space;
the reflecting shell having a top surface and a reflective mirror connecting with the top surface, the reflective mirror curved inward toward a bottom of the receiving space, a light source set up at the top surface, an arc hole opened along a bottom of the reflective mirror wherein the arc hole is corresponding to the arc opening; and
the transparent cover set at another end of the container and in front of the reflecting shell;
wherein most of light from the light source is reflected by the reflecting shell to pass through the transparent cover to brighten the far-ahead traffic, the other light from the light source passes through the arc hole of the reflecting shell, the arc opening of the container, and a bottom of the transparent cover directly to brighten the front road.

2. The bicycle illuminator for brightening traffic as claimed in claim 1, wherein the reflective mirror has an upward-reflective area and a downward-reflective area, a curvature of the upward-reflective area different from a curvature of the downward-reflective area.

3. The bicycle illuminator for brightening traffic as claimed in claim 1, wherein the light source is arranged above the arc hole, thereby most of light are reflected in the reflecting shell rather than passing through the arc hole directly.

4. The bicycle illuminator for brightening traffic as claimed in claim 1, wherein the arc hole is corresponding to the arc opening

5. The bicycle illuminator for brightening traffic as claimed in claim 1, wherein the transparent cover has an arc slot defined therein and corresponding to the arc hole and the arc opening, thereby the diffractions at the transparent cover are reduced and the light from arc hole is brightening the front road immediately.
